(19) United States
(12) Patent Application Publication
(10) Pub. No.: US 2025/0344036 A1
(43) Pub. Date: Nov. 6, 2025

(54) SYSTEM AND METHOD FOR INACTIVATING AND REACTIVATING INTERNET OF THINGS DEVICES

(71) Applicant: Thinaer, Inc., Richardson, TX (US)

(72) Inventors: Taylor VEITH, Wylie, TX (US); Bryan MERCKLING, Rockwall, TX (US)

(21) Appl. No.: 19/196,196

(22) Filed: May 1, 2025

Related U.S. Application Data
(60) Provisional application No. 63/641,791, filed on May 2, 2024.

(51) Int. Cl. H04W 4/021; H04L 12/28; H04W 12/64; H04W 12/79

(52) U.S. Cl. CPC H04W 4/021; H04L 12/28; H04W 12/64; H04W 12/79

(57) ABSTRACT

A system and method for enabling a sensor attached to a moveable item to wirelessly broadcast data signals in an unrestricted area or zone while simultaneously ensuring that the sensor attached to the moveable item stops wirelessly broadcasting the data signals in a classified area or zone, where the sensor is configured to harvest ambient or other RF energy. The system and method include a barrier infrastructure for positioning in the unrestricted area or zone. The barrier infrastructure can include a first device configured to monitor the moveable item via the sensor, as it moves about in the unrestricted area or zone, and cause the sensor to deplete or dump all the ambient or other RF energy that the sensor has harvested if the moveable item is nearing or entering the classified area or zone, so that the sensor deactivates and therefore does not wirelessly broadcast data signals in the classified area or zone. The barrier infrastructure can further include a second device configured to monitor the data signals broadcasted from the sensor attached to the moveable item as the moveable item approaches the classified area or zone, prior to the deactivation of the sensor with the first device, and parse out relevant sensor identifying information contained in the data signals.

### RELATED APPLICATIONS

This application claims the benefit of U.S. Provisional Patent Application No. 63/641,791, filed May 2, 2024, the entire disclosure of which is incorporated herein by reference.

### FIELD

The present disclosure relates to Internet of Things (IoT) devices. More particularly, the present disclosure relates to managing IoT devices that move in and out of secure/restricted areas.

### BACKGROUND

Internet of Things (IoT) are physical objects or items that connect wirelessly to a network, such as the internet, and collect and exchange data with other devices and systems. Examples of IoT devices include, without limitation, items with sensors, cameras, and activity trackers.

The Department of Defense (DOD) has identified numerous security risks with IoT devices and as a result, have developed regulations regarding them in secure areas. Therefore, items destined for secure/restricted areas, such as classified zones, have not been equipped with IoT sensors to prevent the items from emitting any network signals, which would constitute a breach of regulations for these secure areas. This has unfortunately restricted their contribution to IoT oversight, even in non-classified zones and other non-secure/unrestricted areas where such network signals are permissible.

### SUMMARY

Disclosed herein is IoT barrier system and method for use in applications that employ IoT devices, which comprises a mesh barrier infrastructure (mesh infrastructure). The mesh infrastructure enables IoT sensors attached to or otherwise associated with moveable items to broadcast IoT data in unrestricted areas and zones, while simultaneously ensuring that the IoT sensors become inactive upon nearing classified zones or other secure/restricted areas and entering classified zones or other secure/restricted areas. The mesh infrastructure includes a barrier gateway device, which constantly monitors for broadcasting of expected IoT signals and flags any new or different broadcasted IoT signals that may be encroaching upon or broadcasted within a classified zone or other secure/restricted area. Once the IoT sensors exit the classified zone or other secure/restricted area, they reactivate, once again broadcasting IoT signals containing valuable data for IoT applications. Specifically, the combination of a depleting energy bridge device and the barrier gateway device are operative as a virtual wall to prevent the IoT sensors from passing through the classified zones or other secure/restricted areas when active. The barrier gateway device performs monitoring and parsing functions, which allows the system to understand that 1) an IoT sensor is near, and 2) that it should be disabled/drained, and 3) that the IoT sensor was last in that area before moving into the secured area where it is no longer broadcasting.

In various embodiments, the system enables a sensor attached to a moveable item to wirelessly broadcast data signals in an unrestricted area or zone while simultaneously ensuring that the sensor attached to the moveable item stops wirelessly broadcasting the data signals in a classified area or zone, wherein the sensor is configured to harvest ambient or other RF energy. The barrier system, in some embodiments, comprises a barrier infrastructure for positioning in the unrestricted area or zone. The barrier infrastructure can comprise a first device configured to monitor the moveable item via the sensor, as it moves about in the unrestricted area or zone, and cause the sensor to deplete or dump all the ambient or other RF energy that the sensor has harvested if the moveable item is nearing or entering the classified area or zone, so that the sensor deactivates and therefore does not wirelessly broadcast data signals in the classified area or zone. The barrier infrastructure can further comprise a second device configured to monitor the data signals broadcasted from the sensor attached to the moveable item as the moveable item approaches the classified area or zone, prior to the deactivation of the sensor with the first device, and parse out relevant sensor identifying information contained in the data signals.

In some embodiments of the system, the barrier infrastructure further comprises an access point configured to establish a local area network with the first and second devices within the unrestricted area or zone.

In some embodiments of the system, the barrier infrastructure further comprises a IoT gateway device configured to control a flow of the data between a local area network established within the unrestricted area or zone and a cloud-based computing system or device and/or a local computing system or device.

In some embodiments of the system, the first device comprises a depleting energy bridge device.

In some embodiments of the system, the barrier infrastructure further comprises a third device configured to emit RF energy within the unrestricted area or zone, to power the sensor while capturing the wireless signals containing the data broadcasted by the sensor.

In some embodiments of the system, the third device comprises a passive energy bridge device.

In some embodiments of the system, the third device is further configured to emit a burst of extra RF energy to deplete or dump all the ambient or other RF energy that the sensor has harvested so that the sensor deactivates and therefore stops wirelessly broadcasting data signals if the third device detects the movable item approaching the classified area or zone.

In some embodiments of the system, the second device comprises a barrier gateway device.

In some embodiments of the system, the barrier gateway device is positioned adjacent to an entrance of the classified area or zone.

In some embodiments of the system, the barrier gateway device is further configured to continuously monitor for expected data signals and flags any new or different signals that may be encroaching upon the classified area or zone.

In some embodiments of the system, the sensor comprises an IoT sensor, the data comprises IoT data, the first device comprises a depleting energy bridge device and the second device comprises a barrier gateway device, and wherein the barrier infrastructure further comprises a passive energy bridge device configured to emit RF energy within the unrestricted area or zone to power the IoT sensor while capturing the wireless signals containing the IoT data broadcasted by the IoT sensor, an access point, an IoT gateway device, and a cloud-based computing system or device and/or a local computing system or device. The IoT gateway device, the access point, the passive energy bridge device, the depleting energy bridge device, and the barrier gateway device, are communicatively linked together in a mesh arrangement. Further, the access point is configured to establish a local area network with the IoT gateway device, the passive energy bridge device, the depleting energy bridge device, and the barrier gateway device within the unrestricted area or zone. Still further, the IoT gateway device is configured to control a flow of the IoT data between a local area network established by the access point within the unrestricted area or zone and the cloud-based computing system or device and/or the local computing system or device.

In some embodiments of the system, once the moveable item with the sensor exits the classified area or zone and reenters the unrestricted area or zone or another unrestricted area or zone, the sensor resumes harvesting the ambient or other RF energy, reactivates and resumes wirelessly broadcasts the data signals.

In various embodiments, the method enables a sensor attached to a moveable item to wirelessly broadcast data signals in an unrestricted area or zone while simultaneously ensuring that the sensor attached to the moveable item stops wirelessly broadcasting the data signals in a classified area or zone, wherein the sensor is configured to harvest ambient or other RF energy. The method, in some embodiments, comprises monitoring the data signals broadcasted from the sensor attached to the moveable item with a first device, as it moves about in the unrestricted area or zone, depleting or dumping all the ambient or other RF energy that the sensor has harvested with the first device if the moveable item is nearing and/or entering the classified area or zone so that the sensor deactivates and therefore stops wirelessly broadcasting data signals in the classified area or zone, monitoring the data signals broadcasted from the sensor attached to the moveable item with a second device, as the moveable item approaches the classified area or zone, prior to the deactivation of the sensor with the first device, and parsing out relevant sensor identifying information contained in the data signals.

In some embodiments, the method further comprises establishing, with an access point, a local area network with the first and second devices within the unrestricted area or zone.

In some embodiments, the method further comprises controlling, with a IoT gateway device, a flow of the data between a local area network established within the unrestricted area or zone and a cloud-based computing system or device and/or a local computing system or device.

In some embodiments of the method, the first device comprises a depleting energy bridge device.

In some embodiments, the method further comprises emitting RF energy, with a third device, within the unrestricted area or zone, to power the sensor while capturing the wireless signals containing the data broadcasted by the sensor.

In some embodiments of the method, the third device comprises a passive energy bridge device.

In some embodiments, the method further comprises emitting a burst of extra RF energy, with the third device, to deplete or dump all the ambient or other RF energy that the sensor has harvested so that the sensor deactivates and therefore stops wirelessly broadcasting data signals if the third device detects the movable item approaching the classified area or zone.

In some embodiments of the method, the second device comprises a barrier gateway device.

In some embodiments, the method further comprises positioning the barrier gateway device adjacent to an entrance of the classified area or zone.

In some embodiments, the method further comprises continuously monitoring, with the barrier gateway, for expected data signals and flagging any new or different signals that may be encroaching upon the classified area or zone.

In some embodiments, the method further comprises resuming harvesting of the ambient or other RF energy with the sensor if the moveable item with the sensor exits the classified area or zone and reenters the unrestricted area or zone or another unrestricted area or zone, to reactivate the sensor and resume wirelessly broadcasts the data signals.

### BRIEF DESCRIPTION OF THE DRAWING

The disclosure is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and the drawing.

FIG. 1A is a pictorial diagram of an illustrative embodiment of an IoT barrier system of the present disclosure.

FIG. 1B is a block diagram of an illustrative embodiment of the IoT barrier system of the present disclosure.

FIG. 2 is a pictorial diagram of an illustrative embodiment of a monitored movable item with an active IoT sensor approaching a classified area or zone.

FIG. 3 is a block diagram of an illustrative embodiment of a barrier gateway device of the present disclosure.

FIG. 4 is a flow chart of a method for operating the barrier system according to an illustrative embodiment of the present disclosure.

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same. Further, “connected” and “coupled” are not restricted to physical or mechanical connections or couplings. Still further, “wireless signal” refers to electromagnetic waves travelling through the air, and occupy a spectrum, or wide range, of frequencies, i.e., the rate at which a signal vibrates.

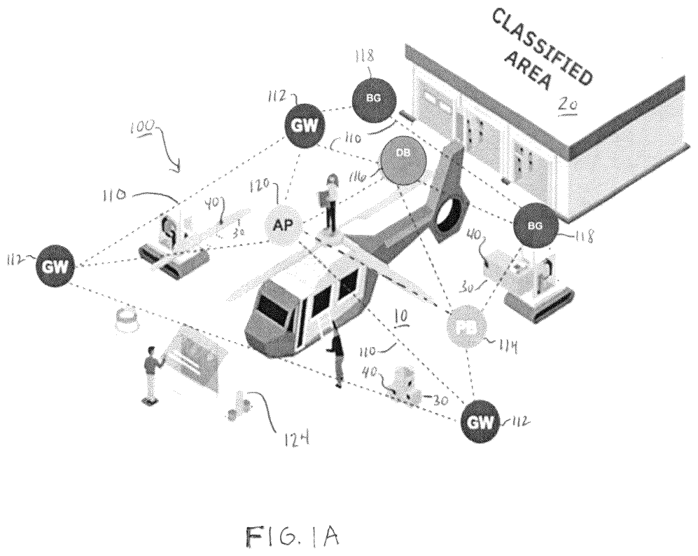

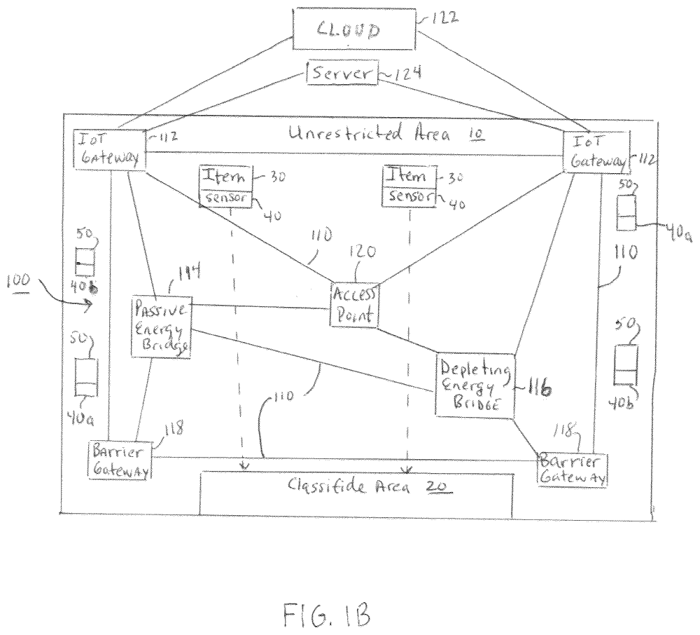

FIGS. 1A and 1B are respective pictorial and block diagrams of illustrative embodiments of an IoT barrier system, hereinafter barrier system 100. The barrier system 100 enables IoT sensors 40 attached to and monitoring moveable assets, raw materials, and the like (hereinafter moveable items 30) to wirelessly broadcast RF signals containing IoT sensor data in unrestricted areas or zones of a physical location (unrestricted area or zone 10 in FIGS. 1A and 1B) while simultaneously ensuring that the IoT sensors 40 become inactive (i.e., stop the wireless broadcast of RF signals containing IoT sensor data) when the moveable items 30 approach and enter classified areas or zones 20 of the same or different physical location. The physical location can include, for example, a building, a room within a building, a hangar, a loading dock, and any other physical location. The barrier system 100 enables the IoT sensors 40 attached to the moveable items 30 to become active again (i.e., resume the wireless broadcast of signals containing IoT sensor data) when the moveable items 30 leave the classified areas or zones 20 and enter or re-enter unrestricted areas or zones 10 of the physical location or a different physical location. In some illustrative embodiments, users receiving the moveable items 30 will attach the IoT sensors 40 to the moveable items 30 and associate the IoT sensors 40 with the moveable items 30 using any suitable means. The IoT sensors 40 are configured to broadcast a signal (e.g., radio frequency (RF) signal) from the physical location of their associated moveable items 30 (e.g., loading dock, forklift paths and the like), which identifies the physical location of the moveable items 30 and thereby allows the location of the moveable items 30 to be tracked. In some illustrative embodiments also monitor various environmental data including, without limitation, heat, light, humidity, vibration, noise, speed, acceleration, etc.

Referring still to FIGS. 1A and 1B, the barrier system 100 comprises a mesh-structured barrier infrastructure 110 (mesh infrastructure 110). The mesh infrastructure 110 is provided in the unrestricted area or zone 10 and comprises a network that can include one or more IoT gateway devices 112, one or more passive energy bridge devices 114, one or more depleting energy passive devices 116, one or more barrier gateway devices 118, and one or more access point devices 120, which operate together to: 1) power the IoT sensors 40 attached to the moveable items 30 as the items 30 move about the unrestricted areas or zones 10; 2) obtain IoT data contained in wireless data signals broadcasted from the IoT sensors 40 attached to the moveable items 30 as the items 30 move about the unrestricted areas or zones 10; 3) monitor the wireless IoT data signals broadcasted from the IoT sensors 40 attached to the moveable items 30 as they move about the unrestricted areas or zones and approach the classified areas or zones 20; 4) cause the IoT sensors 40 attached to the moveable items 30 to become inactive by depleting their energy so they can no longer broadcast wireless IoT data signals (i.e., the IoT sensors 40 “go dark”), as they encroach upon the classified areas or zones 20; and 5) flag any new (unexpected or different) wireless IoT data signals (broadcasted from unexpected or different IoT sensors attached to moveable items) that encroach upon the classified areas or zones 20. The mesh infrastructure 110 of the barrier system 100 combines security with efficiency, thereby optimizing data collection while complying with regulations that prohibit wireless IoT data broadcasting/transmission in classified areas and zones (classified area or zone 20 in FIGS. 1A and 1B).

In some illustrative embodiments, the IoT sensors 40 attached to the moveable items 30 each comprises passive (battery-free), wireless signaling hardware, which IoT sensors 40 (hereinafter battery-free sensors 40) can be configured as a beacon, sticker, or tag. Battery-free IoT sensors 40 are well known in the IoT art and include passive wireless signaling hardware, which harvests ambient radio frequency (RF) energy from various RF sources that powers the wireless signaling hardware of the IoT sensor 40. In some illustrative embodiments, the battery-free IoT sensors 40 can be conventionally configured as a Bluetooth Low Energy (BLE) beacons, stickers, and/or tags. In other illustrative embodiments, the battery-free IoT sensors 40 can be conventionally configured as a Long Range (LoRa) beacons, stickers, and/or tags. In still other illustrative embodiments, the battery-free IoT sensors 40 can be conventionally configured as a radio frequency identification (RFID) beacon, sticker, and/or tag. In the present disclosure, the battery-free IoT sensors 40 are powered primarily by the ambient RF energy harvested from the passive energy bridge devices 114 and the depleting passive bridges 116 located in the unrestricted areas or zones 10. However, the battery-free IoT sensors 40 can also harvest ambient RF energy from other sources located in the unrestricted areas or zones 10, such as the one or more access points 120, the one or more IoT gateways 112, and/or the one or more barrier gateways 118. The passive wireless signaling hardware of the battery-free IoT sensors 40 is non-connectable by design, and so the battery-free IoT sensors 40 only broadcast wireless IoT data signals and do not receive wireless data signals.

In some illustrative embodiments, as depicted in FIG. 1B, battery-free IoT sensors 40a can also be attached to stationary items 50 including without limitation any building walls, ceilings, and doors in the unrestricted areas or zones 10, to further track the location of the moveable items 30, and in some embodiments, monitor environmental data of the moveable items 30. In other illustrative embodiments, one or more of the stationary items 50 can be tagged with powered IoT sensors 40b, which include active (powered by a battery or wired to or connected to an electrical source such as an electrical outlet) wireless IoT data signaling hardware configured as a beacon, sticker, or tag. The powered IoT sensors 40b configured with active wireless data signaling hardware are connectable, and therefore, can receive configuration information (e.g., “broadcast temperature and humidity every 5 seconds, and broadcast only temperature once every 3 seconds”).

The access point device 120 depicted in FIGS. 1A and 1B, is configured to establish a wireless local area network (LAN) within the unrestricted area or zone 10 with the one or more IoT gateway devices 112, the one or more passive energy bridge devices 114, the one or more depleting energy passive bridge devices 116 and the one or more barrier gateway devices 118. Access point devices such as access point 120 are well known in the wireless networking art and can comprise any suitable and well known, powered wireless networking edge device that can be configured to establish the LAN with the IoT gateway device(s) 112, passive energy bridge device(s) 114, depleting energy passive bridge device(s) 116 and the barrier gateway device(s) 118, within the unrestricted area or zone 10. In some illustrative embodiments, the access point device 120 can comprise a Wifi access point. In some embodiments, the access point device 120 can be further configured to capture IoT data broadcasted wirelessly from the battery-free IoT sensors 40 and transmit the IoT data to a cloud-based server 122 (FIG. 1B) or a local server 124. In still other embodiments, the access point device 120 can also be configured to wirelessly receive IoT data broadcasted by the battery-free IoT sensors 40 and 40a in any signal format including, but not limited to BLE, RFID, and/or LoRa signal formats. In still further embodiments, the access point device 120 can also be configured to receive wireless IoT data signal and other wireless data signals to and from the powered IoT sensors 40b, the one or more IoT gateway devices 112, the one or more passive energy bridge devices 114, the one or more depleting energy passive bridges 116, and the one or more barrier gateway devices 118 in any signal format including, but not limited to Wifi, BLE, RFID, and/or LoRa signal formats. Although only one access point 120 is depicted in FIGS. 1A and 1B, multiple access points 120 can be provided in the unrestricted area or zone 10 to expand the footprint of the LAN, or where the access point 120 is actively participating in data collection, to expand the data collection coverage.

In some illustrative embodiments, as depicted in FIGS. 1A and 1B, the one or more IoT gateway devices 112 are operative in the mesh infrastructure 110 for data connecting or data linking the access point device 120, the battery-free IoT sensors 40 of the moveable items 30, the battery-free IoT sensors 40a and the powered IoT sensors 40b of the stationary items 50, the one or more passive energy bridges 114, the one or more depleting energy passive bridges 116 and the one or more barrier gateways 118 together. In some further embodiments, the access point device 120 is also configured to pass the wirelessly and wired captured data to a cloud-based server 122 (FIG. 1B) and/or to a local server 124 (FIGS. 1A and 1B). In particular, the one or more IoT gateway devices 112 can serve as data entry and data exit points to control the flow of data between the LAN established by the access point(s) 120 and the cloud-based server 122 (FIG. 1B) and/or to the local server 124 (FIGS. 1A and 1B). The one or more IoT gateway devices 112 can comprise any suitable and well known powered edge device such as a MINEW MG3 USB MINI GATEWAY, which has been configured to capture wireless data signals containing tracking and/or environmental data (IoT data) broadcasted by the battery-free IoT sensors 40 attached to the moveable items 30 and the battery-free IoT sensors 40a and the powered IoT sensors 40b attached to the stationary items 50, in any wireless signal format within the unrestricted area or zone 10, including without limitation BLE, RFID, and/or LoRa signal formats. In addition, the IoT gateway devices 112 can be further configured to receive wireless IoT data signals captured by and transmitted from the access point device 120, and in some illustrative embodiments, is configured to aggregate and synchronize the IoT data, and/or pre-process the IoT data. Embodiments with multiple IoT gateways 112 can be further configured to wirelessly communicate configuration information amongst each other including, without limitation, which LAN to connect to in embodiments with multiple access point devices 120, and to exchange data packets that can be used to estimate distance between themselves by measuring Received Signal Strength Indicator (RSSI) values and time. One or more of the IoT gateway devices 112 can also be configured to wirelessly transmit the IoT data to the access point 120 (FIG. 1B) and/or to the local server 124 (FIG. 1A) via a wired data connection, as a connection backup. The cloud-based server 122 and/or the local server 124 are each configured to provide analytics, actionable intelligence, and monitoring of the battery-free IoT sensors 40 attached to the items 30 and the battery-free IoT sensors 40a and the powered IoT sensors 40b attached to the stationary items 50. If an IoT gateway 112 has not yet been configured (either by the user or another IoT gateway 112), the IoT gateway 112 will cache records offline until it is able to connect to the cloud-based server 122 and/or the local server 124, at which point it will upload that cached data to the cloud-based server 122 and/or local server 124. The IoT gateway devices 112 can also be configured to data communicate with the one or more access points 120, the one or more passive energy bridges 114, the one or more depleting energy passive bridges 116 and the one or more barrier gateways 118 in any signal format including, but not limited to Wifi, BLE, RFID, and/or LoRa signal formats.

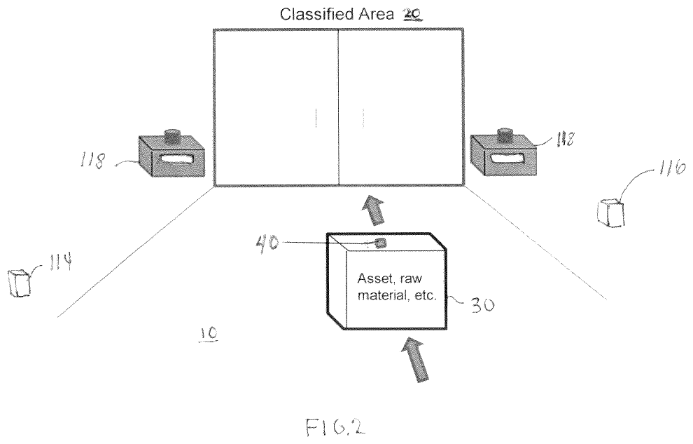

The one or more passive energy bridge devices 114 are located near the entrance to the classified area or zone 20, within the unrestricted area or zone 10, so they can monitor and detect any moveable items 30 approaching the classified area or zone 20 that have active battery-free IoT sensors 40 that are wirelessly broadcasting IoT data signals. Specifically, the one or more passive energy bridge devices 114 each have a number of functions: 1) providing power to cause the IoT sensors 40 to wake up and send IoT data; 2) listening for the IoT sensors 40 to send IoT data, so that that the IoT data can be captured and subsequently relayed to and through the mesh network infrastructure 110 and eventually back to the cloud-based server 122 or the local server 124 for processing; 3) to receive data from the cloud-based server 122 or the local server 124 via the mesh network infrastructure 110; and 4) to deplete the IoT sensor's 40 RF energy so that it becomes inactive, thereby allowing its corresponding moveable item 30 to enter and move through the classified area or zone 20. The one or more passive energy bridge devices 114 can each comprise any suitable and well known, powered bridge device that includes an antenna array that is configured to emit RF energy (e.g., BLE, LoRa, and/or RFID) in either an omnidirectional or directional manner within the unrestricted area or zone 10 to power the battery-free IoT sensors 40, 40a, while capturing wireless signals containing IoT data broadcasted by the battery-free IoT sensors 40, 40a and the powered IoT sensors 40b. Each passive energy bridge device 114 and its antenna array are also configured to emit a burst of extra RF energy when the passive energy bridge device 114 detects a monitored movable item 30, with an active IoT sensor 40 wirelessly broadcasting IoT data, approaching a classified area or zone 20 (FIG. 2). The extra burst of RF energy emitted from the passive energy bridge device 114 triggers a certain functionality in the active IoT sensor 40 of the approaching moveable item 30 that quickly depletes or dumps all the ambient or other energy that the IoT sensor 40 may have harvested so that the IoT sensor 40 becomes inactive, i.e., stops wirelessly broadcasting IoT data and goes dark. Once the IoT sensor 40 of the movable item 30 goes dark, the moveable item 30 and its attached IoT sensor 40 can enter the classified area or zone 20.

In some illustrative embodiments, the one or more passive energy bridge devices 114 can be further configured to route the captured IoT data directly to the one or more IoT gateway devices 112 and/or directly to access point(s) 120 in any signal format including, but not limited to Wifi, BLE, RFID, and/or LoRa signal formats to route the captured IoT data directly to the one or more IoT gateway devices 112 and/or to the access point(s) 120.

The one or more passive energy bridge devices 114 are well known in the IoT art and are readily available from various manufactures. For example, but not limitation, the passive energy bridge device(s) 114 can comprise a TX SYSTEMS Power Hub 1W Power bridge manufactured by ENERGOUS, an Eagle (1W) Omni-directional PowerBridge manufactured by ENERGOUS, and/or a BRX840XE Dual Band Bridge with a LoRa antenna and a BLE antenna manufactured by FANSTEL.

The one or more depleting passive bridge devices 116 are located between the one or more passive energy bridge devices 114 and typically within 30 feet of the entrance to the classified area or zone 20, within the unrestricted area or zone 10, so they can monitor and detect any moveable items 30 closely approaching the classified area or zone 20 that still have active battery-free IoT sensors 40 that are wirelessly broadcasting IoT data signals (FIG. 2). The one or more depleting passive bridge devices 116 can each comprise any suitable and well known, powered bridge device that includes an antenna array that is configured to emit RF energy (e.g., BLE, LoRa and/or RFID) in a highly directional or focused manner within the unrestricted area or zone 10 to power the battery-free IoT sensors 40 40a, while capturing wireless signals containing IoT data broadcasted by the battery-free IoT sensors 40, 40a and the powered IoT sensors 40b. In particular, each depleting passive bridge device 116 and its antenna array are configured to continuously focus extra RF energy in the area of any monitored moveable item 30 and its attached battery-free IoT sensor 40 that is crossing its path and approaching the classified area or zone 20. The directionally focused extra RF energy emitted from the depleting passive bridge device 116 triggers the earlier mentioned functionality in the active battery-free IoT sensor 40 of the approaching moveable item 30 that quickly depletes or dumps all the ambient or other energy it may have harvested and still have so that the battery-free IoT sensor 40 becomes inactive, i.e., stops wirelessly broadcasting IoT data and goes dark. Once the battery-free IoT sensor 40 of the movable item 30 goes dark, the moveable item 30 and its attached battery-free IoT sensor 40 can enter the classified area or zone 20.

The depleting passive bridge device(s) 116 are well known in the IoT art and are readily available from various manufactures. For example, but not limitation, the depleting passive bridge device(s) can comprise a TX SYSTEMS Power Hub 1W Power Bridge configured in a directional mode. The depleting passive bridge device(s) 116 can be configured to data communicate with one or more of the IoT gateway devices 112 and the access point(s) 120 in any signal format including, but not limited to Wifi, BLE, RFID, and/or LoRa signal formats to route the captured IoT data directly to the one or more IoT gateway devices 112 and/or directly to access point(s) 120.

The one or more barrier gateway devices 118 are located adjacent to the classified area or zone 20, typically within 30 feet of the classified area or zone 20, and are configured to monitor IoT data signals broadcasted from battery-free IoT sensors 40 attached to moveable items 30 approaching the classified area or zone 20 devices (FIG. 2) and parse out relevant IoT sensor 40 identifying information (IoT sensor identifiers) contained in the IoT data signals. The barrier gateway devices 118 are configured to interact with a web service to maintain a list (based on the IoT sensor identifiers) of what moveable items 30 with attached battery-free IoT sensors 40 should and should not be nearby. When a moveable item 30 with an attached battery-free IoT sensor 40 with a known identifier is found, the barrier gateway device 118 flags it digitally, such as noting or logging the presence of the IoT device 40 in a remote database or in an email with the intention that this data can be reviewed by a user or software, or business logic on the IoT device itself, to decide whether action should be taken, e.g., sending a person out to prevent the IoT device 40 from entering the secured area, and can trigger an alert visually with a flashing light and/or an audible sound depending on the alert rules. In addition, the barrier gateway devices 118 can be configured with any well known, commercially available machine learning and artificial intelligence software, which enables the barrier gateway devices 118 to learn about and subsequently recognize IoT data signals that remain constant within their monitoring range in the unrestricted area or zone 10. When a new and/or different IoT data signal broadcasted by a battery-free IoT sensor 40 of a moveable item 30 approaches the classified area or zone 20, the barrier gateway 118 passes an alert via the one or more IoT gateways 112 to the cloud-based server 122 or local server 124 based alert and resolution engine, to be processed based on notification rules. Specifically, the alert/resolution engine manages the rest of the process and includes all of the severity levels, timing of initial alerts, timing of secondary alerts, what constitutes resolved, etc.

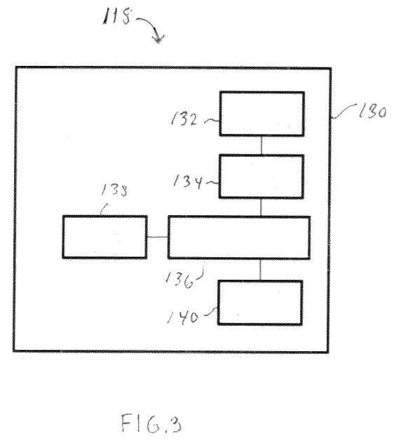

FIG. 3 is a block diagram of an illustrative embodiment of a barrier gateway 118 device according to the present disclosure. The barrier gateway device 118 is a powered device comprising a housing or case 130 that encloses a wireless communication/radio module 134, an antenna module 132, a micro-computer 136, a visual/audible alert module 138, and a power supply 140.

The communication module 134 and antenna module 132 of the barrier gateway device 118 operate to enable the barrier gateway device 118 to receive and transmit wireless RF signals to the one or more IoT gateway devices 112, and the one or more access point devices 120 and the one or more passive bridges 114 and the one or more depleting passive bridges 116 and to monitor and detect wireless IoT data signals broadcasting from battery-free IoT sensors 40 attached to moveable items 30 that are approaching the classified area or zone 20 and the battery-free IoT sensors 40a and powered IoT sensors 40b attached to the stationary items 50. In some illustrative embodiments, the wireless communication module 134 can comprise any suitable and well known conventional BLE communication module and the associated antenna module 132 can comprise any suitable and well known BLE antenna module. In other illustrative embodiments, the communication module 134 can comprise or further comprise any suitable and well known LoRa communication module and the associated antenna module 132 can comprise or further comprise any suitable and well known LoRa antenna module. In still other illustrative embodiments, the communication module 134 can comprise or further comprise any suitable and well known RFID communication module and the associated antenna module 132 can comprise or further comprise any suitable and well known RFID antenna module.

The micro-computer 136 of the barrier gateway device 118 is configured with software and/or hardware that enables the barrier gateway device 118 to: 1) parse out relevant identifying information (identifiers) for known battery-free IoT sensors 40 that are wirelessly broadcasting IoT data signals that are received and detected with the communication module 134 and the antenna module 132; and 2) 2-way data communicate (transmit and receive) with a web service, the one or more IoT gateway devices 112, and the one or more access point devices 120, the one or more passive energy bridge devices 114, and the one or more depleting passive bridge devices 116, via the communication module 134 and antenna module 132. The micro-computer includes software and a database which maintains the list of which battery-free IoT sensors 40 and their attached moveable items 30 are allowed to be approaching the classified area or zone 20 and which battery-free IoT sensors 40 their attached moveable items 30 are not allowed to be approaching the classified area or zone 20. The micro-computer 136 can also be configured with any well known, commercially available software and/or hardware that enables the barrier gateway device 118 to flag/identify battery-free IoT sensors 40 with known IoT identifiers via the alert or the email while causing the visual/audible alert module 138 to flash a light on the case 130 and/or make a speaker on the case 130 make an audible sound. The micro-computer 136 can also be configured with any well known, commercially available machine learning and artificial intelligence software, which enables the barrier gateway device 118 to learn about and subsequently recognize IoT data signals from battery-free IoT sensors 40, 40a and the powered IoT sensors 40b that remain constant within its monitoring range. In some illustrative embodiments, the micro-computer 136 can comprise a micro-computer with a quad core processor or any other suitable well known micro-computer.

The one or more access point devices 120, the one or more passive energy bridge devices 114, the one or more depleting passive bridge devices 116, and the one or more barrier gateway devices 118 can be configured to receive various configuration instructions. Specifically, the one or more access point devices 120 and the one or more barrier gateway devices 118 can be configured to receive configuration instructions from the cloud-based server 122 or local server 124 and the one or more passive energy bridge devices 114 and the one or more depleting passive bridge devices 116 can be configured to receive configuration instructions from the one or more IoT gateway devices 112. Additionally, the one or more barrier gateway devices 118 can be configured to receive supplemental information, such as the earlier mentioned IoT sensor identifiers from the cloud server 122 or local server 124 about which signals it should or should not alert on.

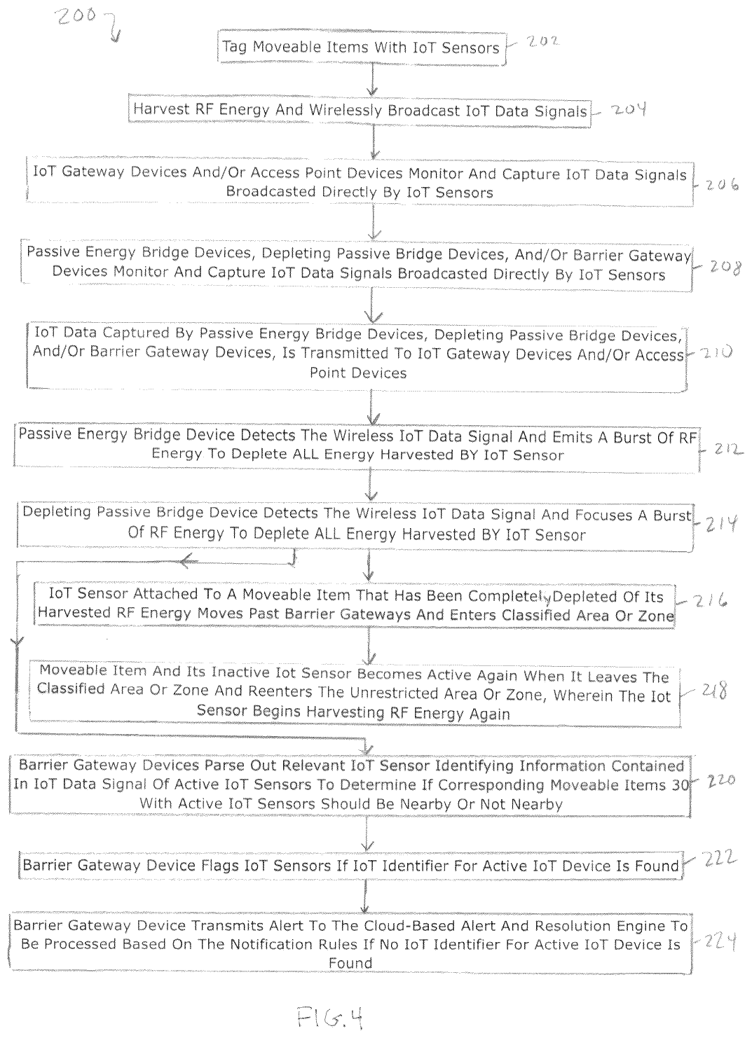

FIG. 4 is a flow chart of a method 200 for operating the barrier system 100 according to an illustrative embodiment of the present disclosure. The method 200 will be described with reference to unrestricted area or zone 10 and classified area or zone 20 illustrated in FIGS. 1A and 1B.

The method 200 commences in box 202 where the moveable items 30 bound for the classified areas or zones 20 are tagged with the battery-free IoT sensors 40. As described above, these battery-free IoT sensors 40 wirelessly broadcast IoT data signals, but only in the unrestricted area or zone 10 where wireless signals are allowed.

In box 204, the battery-free IoT sensors 40 attached to the moveable items 30 harvest RF energy from the passive energy bridge devices 114 and the depleting passive bridges 116 (and ambient RF energy from other sources, such as the one or more access points 120, the one or more IoT gateways 112, and/or the one or more barrier gateways 118), as the moveable items 30 move about and/or are transported through the unrestricted area or zone 10. The harvested RF energy enables the battery-free IoT sensors 40 to wirelessly broadcast IoT data signals, as the moveable items 30 move about and/or are transported through the unrestricted area or zone 10

In box 206, the one or more IoT gateway devices 112 and/or the access point device(s) 120 monitor for and capture wireless IoT data signals broadcasted directly by the battery-free IoT sensors 40 attached to the moveable items 30 and the battery-free IoT sensors 40a and the powered IoT sensors 40b attached to the stationary items 50, as the moveable items 30 move about and are transported through the unrestricted area or zone 10. In particular, each battery-free IoT sensor 40, 40a and each powered IoT sensor 40b broadcasts a data packet. Within the data packet will be data associated with each of the sensor's abilities, ex: temp, humidity, vibration. RSSI is generated and included with each packet which is used for trilateration (locationing). This data can be used for visualization in table and graph form and for generating range based alerts, including for example left an area, temperature exceeded, vibration exceeded, voltage is out of range, etc.

In box 208, the one or more passive energy bridge devices 114, the one or more depleting passive bridge devices 116, and/or the one or more barrier gateway devices 118, monitor for and capture IoT data signals wirelessly broadcasted by the battery-free IoT sensors 40 attached to the moveable items 30 and the battery-free IoT sensors 40a and the powered IoT sensors 40b attached to the stationary items 50, as the moveable items 30 move about and are transported through the unrestricted area or zone 10.

In box 210, the IoT data captured by the one or more passive energy bridge devices 114, the one or more depleting passive bridge devices 116, and/or the one or more barrier gateway devices 118, is transmitted to the one or more IoT gateway devices 112 and/or the access point device(s) 120 and, the access point device(s) 120 pass(es) the IoT data to the cloud-based server 122 or local server 124 based alert and resolution engine to be processed based on notification rules.

In box 212, if a battery-free IoT sensor 40 attached to a moveable item 30 begins to approach the classified area or zone 20 and is wirelessly broadcasting IoT data signals and is therefore, active, the passive energy bridge device 114 in range of that battery-free IoT sensor 40 detects the wireless IoT data signal and in response thereto, emits a burst of RF energy that causes the battery-free IoT sensor 40 to quickly deplete or dump all its ambient or other energy that the battery-free IoT sensor 40 has harvested so that the battery-free IoT sensor 40 stops wirelessly broadcasting IoT data signals.

In box 214, if the battery-free IoT sensor 40 attached to the moveable item 30 continues further toward the classified area or zone 20 and is still wirelessly broadcasting IoT data signals and is therefore, still active, or if another battery-free IoT sensor 40 attached to another moveable item 30 moves toward the classified area or zone 20 and is still wirelessly broadcasting IoT data signals and is therefore, still active, the depleting passive bridge device 116 acts as a barrier using focused highly directional RF energy across classified entryways, which causes any battery-free IoT sensor 40 to quickly deplete or dump the remainder of its harvested ambient or other energy so that the battery-free IoT sensor 40 stops wirelessly broadcasting IoT data signals.

In box 216, if a battery-free IoT sensor 40 attached to a moveable item 30 continues further on toward the classified area or zone 20 and has been completely depleted of its harvested RF energy and is rendered inactive by the one or more passive energy bridge devices 114 and/or the one or more depleting passive bridge devices 116, the moveable item 30 and its inactive battery-free IoT sensor 40 will move past the one or more barrier gateways 118 and enter the classified area or zone 20 without breaching any DOD regulations regarding IoT broadcasting. Since the battery-free IoT sensor 40 is no longer broadcasting as it enters the classified area or zone 20, the barrier gateways 118 are unable to record its actual entry into the classified area or zone 20 and the only record of its last location is based on where it was before it was fully depleted of power by the passive energy bridge device 114 or the depleting passive bridge device 116. The cloud server 122 and/or local server 124 maintains a record of the last known location of the battery-free IoT sensor 40 prior to full power depletion, which location will be classified as entry/exit.

In box 218, the moveable item 30 and its inactive IoT sensor becomes active again when it leaves the classified area or zone 20 and reenters the unrestricted area or zone 10, wherein the battery-free IoT sensor 40 begins harvesting RF energy from the passive energy bridge devices 114 and the depleting passive bridges 116 and/or ambient RF energy from other sources, such as the one or more access points 120, the one or more IoT gateways 112, and/or the one or more barrier gateways 118, as the moveable item 30 moves about and/or is transported through the unrestricted area or zone 10.

In box 220, if any battery-free IoT sensor 40 attached to a moveable item 30 continues further on toward the classified area or zone 20 past the one or more passive energy bridge devices 114 and the one or more depleting passive bridge devices 116, and is still wirelessly broadcasting IoT data signals and is therefore, still active, the barrier gateway device 118 in range of that battery-free IoT sensor 40 will detect the wireless IoT data signal and in response thereto, parse out relevant IoT sensor identifying information contained in the IoT data signal to determine if the moveable item 30 with that battery-free IoT sensor 40 should be nearby the classified area or zone and allowed to enter the classified area or zone 20 once the battery-free IoT sensor 40 has stopped wirelessly broadcasting IoT data signals or should not be nearby and allowed to enter the classified area or zone 20.

In box 222, if the barrier gateway device 118 finds the IoT identifier for the battery-free IoT sensor 40 and therefore, determines that the moveable item 30 with that battery-free IoT sensor 40 should be nearby and allowed to enter the classified area or zone 20 once the battery-free IoT sensor 40 has stopped wirelessly broadcasting IoT data signals, the barrier gateway device 118 will flag the battery-free IoT sensor 40 and will alert with an email and visually flash its indicator light and/or activate its speaker to make an audible sound if an identifier is found for that battery-free IoT sensor 40. The moveable item 30 will then be manually stopped for full power depletion of any battery-free IoT sensor 40. In some illustrative embodiments, one or more of the moveable items 30 can have a battery powered IoT sensor (not shown), which can be monitored like the other battery-free IoT sensors 40, 40a and powered IoT sensors 40b, but cannot be depleted by the one or more passive energy bridge devices 114 or the one or more depleting passive bridge devices 116. Therefore, if the moveable item 30 has such a battery powered IoT sensor and that sensor is still active (battery power is not fully drained), the active battery powered IoT sensor can be manually deactivated at the method step of box 222, and removed from the moveable item 30.

In box 224, if the barrier gateway device 118 does not find the identifier for the battery-free IoT sensor 40 and therefore, determines that the moveable item 30 with that battery-free IoT sensor 40 should not be nearby the classified area or zone 20, the barrier gateway device 118 will transmit an alert via the one or more IoT gateway devices 112 to the cloud-based alert and resolution engine to be processed based on the notification rules. The resulting action can include, but is not limited to the newly identified battery-free IoT sensor 40 being added to the list of allowed sensors, the moveable item 30 being disallowed from entering the classified area and the IoT sensor (either the battery-free IoT sensor 40 or the battery-powered IoT sensor) being removed from the moveable item 30 prior to the moveable item 30 entering a classified area.

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. A system for enabling a sensor attached to a moveable item to wirelessly broadcast data signals in an unrestricted area or zone while simultaneously ensuring that the sensor attached to the moveable item stops wirelessly broadcasting the data signals in a classified area or zone, wherein the sensor is configured to harvest ambient or other RF energy, the barrier system comprising:
a barrier infrastructure for positioning in the unrestricted area or zone, the barrier infrastructure comprising:
a first device configured to:
monitor the moveable item via the sensor, as it moves about in the unrestricted area or zone; and
cause the sensor to deplete or dump all the ambient or other RF energy that the sensor has harvested if the moveable item is nearing or entering the classified area or zone, so that the sensor deactivates and therefore does not wirelessly broadcast data signals in the classified area or zone; and
a second device configured to:
monitor the data signals broadcasted from the sensor attached to the moveable item as the moveable item approaches the classified area or zone, prior to the deactivation of the sensor with the first device; and
parse out relevant sensor identifying information contained in the data signals.

2. The system of claim 1, wherein the barrier infrastructure further comprises an access point configured to establish a local area network with the first and second devices within the unrestricted area or zone.

3. The system of claim 1, wherein the barrier infrastructure further comprises a IoT gateway device configured to control a flow of the data between a local area network established within the unrestricted area or zone and a cloud-based computing system or device and/or a local computing system or device.

4. The system of claim 1, wherein the first device comprises a depleting energy bridge device.

5. The system of claim 1, wherein the barrier infrastructure further comprises a third device configured to emit RF energy within the unrestricted area or zone, to power the sensor while capturing the wireless signals containing the data broadcasted by the sensor.

6. The system of claim 5, wherein the third device comprises a passive energy bridge device.

7. The system of claim 5, wherein the third device is further configured to emit a burst of extra RF energy to deplete or dump all the ambient or other RF energy that the sensor has harvested so that the sensor deactivates and therefore stops wirelessly broadcasting data signals if the third device detects the movable item approaching the classified area or zone.

8. The system of claim 1, wherein the second device comprises a barrier gateway device.

9. The system of claim 8, wherein the barrier gateway device is positioned adjacent to an entrance of the classified area or zone.

10. The system of claim 9, wherein the barrier gateway device is further configured to continuously monitor for expected data signals and flags any new or different signals that may be encroaching upon the classified area or zone.

11. The system of claim 1, wherein the sensor comprises an IoT sensor, the data comprises IoT data, the first device comprises a depleting energy bridge device and the second device comprises a barrier gateway device, and wherein the barrier infrastructure further comprises:
a passive energy bridge device configured to emit RF energy within the unrestricted area or zone to power the IoT sensor while capturing the wireless signals containing the IoT data broadcasted by the IoT sensor;
an access point;
an IoT gateway device; and
a cloud-based computing system or device and/or a local computing system or device;
wherein the IoT gateway device, the access point, the passive energy bridge device, the depleting energy bridge device, and the barrier gateway device, are communicatively linked together in a mesh arrangement;
wherein the access point is configured to establish a local area network with the IoT gateway device, the passive energy bridge device, the depleting energy bridge device, and the barrier gateway device within the unrestricted area or zone; and
wherein the IoT gateway device is configured to control a flow of the IoT data between a local area network established by the access point within the unrestricted area or zone and the cloud-based computing system or device and/or the local computing system or device.

12. The system of claim 1, wherein once the moveable item with the sensor exits the classified area or zone and reenters the unrestricted area or zone or another unrestricted area or zone, the sensor resumes harvesting the ambient or other RF energy, reactivates and resumes wirelessly broadcasts the data signals.

13. A method for enabling a sensor attached to a moveable item to wirelessly broadcast data signals in an unrestricted area or zone while simultaneously ensuring that the sensor attached to the moveable item stops wirelessly broadcasting the data signals in a classified area or zone, wherein the sensor is configured to harvest ambient or other RF energy, the method comprising:
monitoring the data signals broadcasted from the sensor attached to the moveable item with a first device, as it moves about in the unrestricted area or zone,
depleting or dumping all the ambient or other RF energy that the sensor has harvested with the first device if the moveable item is nearing and/or entering the classified area or zone so that the sensor deactivates and therefore stops wirelessly broadcasting data signals in the classified area or zone;
monitoring the data signals broadcasted from the sensor attached to the moveable item with a second device, as the moveable item approaches the classified area or zone, prior to the deactivation of the sensor with the first device; and
parsing out relevant sensor identifying information contained in the data signals.

14. The method of claim 13, further comprising establishing, with an access point, a local area network with the first and second devices within the unrestricted area or zone.

15. The method of claim 13, further comprising controlling, with a IoT gateway device, a flow of the data between a local area network established within the unrestricted area or zone and a cloud-based computing system or device and/or a local computing system or device.

16. The method of claim 13, wherein the first device comprises a depleting energy bridge device.

17. The method of claim 13, further comprising emitting RF energy, with a third device, within the unrestricted area or zone, to power the sensor while capturing the wireless signals containing the data broadcasted by the sensor.

18. The method of claim 17, wherein the third device comprises a passive energy bridge device.

19. The method of claim 17, further comprising emitting a burst of extra RF energy, with the third device, to deplete or dump all the ambient or other RF energy that the sensor has harvested so that the sensor deactivates and therefore stops wirelessly broadcasting data signals if the third device detects the movable item approaching the classified area or zone.

20. The method of claim 13, wherein the second device comprises a barrier gateway device.

21. The method of claim 20, further comprising positioning the barrier gateway device adjacent to an entrance of the classified area or zone.

22. The method of claim 21, is further comprising continuously monitoring, with the barrier gateway, for expected data signals and flagging any new or different signals that may be encroaching upon the classified area or zone.

23. The method of claim 13, further comprising resuming harvesting of the ambient or other RF energy with the sensor if the moveable item with the sensor exits the classified area or zone and reenters the unrestricted area or zone or another unrestricted area or zone, to reactivate the sensor and resume wirelessly broadcasts the data signals.
